(19) United States
(12) Patent Application Publication
(10) Pub. No.: US 2025/0126128 A1
(43) Pub. Date: Apr. 17, 2025

(54) METHODS AND APPARATUS TO DETERMINE TEMPLATES FOR USE WITH CLOUD ACCOUNTS

(71) Applicant: VMware LLC, Palo Alto, CA (US)

(72) Inventors: Manish Jain, Faridabad (IN); Siddharth Sukumar Burle, Pune (IN); Vishal Gupta, Ludhiana (IN); Manoj Kumar Jain, Pune (IN); Neeraj Pramod Shah, Pune (IN); Chaitrali Talegaonkar, Pune (IN); Sagar Sheetalchandra Hukkeri, Pune (IN); Ashitosh Dilip Wagh, Pune (IN)

(21) Appl. No.: 18/651,505

(22) Filed: Apr. 30, 2024

(30) Foreign Application Priority Data
Oct. 14, 2023 (IN) 202341069352

(51) Int. Cl. H04L 9/40

(52) U.S. Cl. CPC H04L 63/102; H04L 63/20

(57) ABSTRACT

An example apparatus comprises memory, first instructions, and programmable circuitry to be programmed by the first instructions to associate a first portion of metadata with a first category, the metadata corresponding to a cloud resource of a cloud account, associate a second portion of the metadata with a second category, and determine a template based on the first portion being greater than the second portion, the template associated with the first category, the template including second instructions to define a target state to be enforced on the cloud account.

### RELATED APPLICATIONS

This application claims priority to Indian Application No. 202341069352 filed Oct. 14, 2023, by VMware LLC, entitled “METHODS AND APPARATUS TO DETERMINE TEMPLATES FOR USE WITH CLOUD ACCOUNTS,” which is hereby incorporated by reference in its entirety for all purposes.

### FIELD OF THE DISCLOSURE

This disclosure relates generally to cloud computing and, more particularly, to methods and apparatus to determine templates for use with cloud accounts.

### BACKGROUND

In recent years, cloud-based systems have enabled distribution and scalability of computational services and/or resources across virtual networks. Cloud accounts are used to manage and operate cloud deployments that are deployed across such virtual networks. A cloud account is a subscription to a cloud service provider for an organization that corresponds to a group or line of business. An organization can have one or more users who have access to all resources and services associated with a cloud account and can grant access to additional users. The users can manage cloud services of deployments belonging to the cloud account.

### BRIEF DESCRIPTION OF THE DRAWINGS

FIG. 1 is a block diagram of an example environment in which example template recommendation controller 101 operates to determine an example template to enforce target states on an example cloud account.

FIG. 2 is a block diagram of an example implementation of the example template recommendation controller of FIG. 1.

FIG. 3 is an example process flow implementing the example template recommendation controller of FIG. 2.

FIG. 4 illustrates an example user interface constructed in accordance with teachings disclosed herein.

FIG. 5 is a flowchart representative of example machine readable instructions and/or example operations that may be executed, instantiated, and/or performed by example programmable circuitry to implement the template recommendation controller of FIG. 2.

FIG. 6 is a block diagram of an example processing platform including programmable circuitry structured to execute, instantiate, and/or perform the example machine readable instructions and/or perform the example operations of FIG. 5 to implement the template recommendation controller of FIG. 2.

FIG. 7 is a block diagram of an example implementation of the programmable circuitry of FIG. 6.

FIG. 8 is a block diagram of another example implementation of the programmable circuitry of FIG. 6.

FIG. 9 is a block diagram of an example software/firmware/instructions distribution platform (e.g., one or more servers) to distribute software, instructions, and/or firmware (e.g., corresponding to the example machine readable instructions of FIG. 5) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

Cloud accounts are created for specific cloud providers (e.g., Microsoft Azure, Amazon Web Services (AWS), Google Cloud Platform, etc.) and can be accessed through tools that provide a wide range of functionality. End users can implement such services to create templates for managing, provisioning, deploying, governing, scaling, and/or enforcing deployments across the variety of cloud regions associated with their cloud accounts. For example, the users can define and enforce a target state or desired state for an operation of a cloud account. As used herein, a “target state” or “desired state” of a cloud deployment or virtual machine is a set of machine readable policies defining an arrangement or set-up (e.g., configuration) of hardware (e.g., a central processing unit (CPU), memory, etc.) and/or software (e.g., operating systems, applications, etc.). Such machine readable policies can be based on performance tuning efforts, resource capacity reclamation, licensing requirements, and/or other business-related aspects. The target or desired state can be a configuration file that includes settings for resource instances of the deployment, such as network configuration settings, storage settings, security settings, advanced settings, performance settings, etc.

As used herein, a “template” or an “Out of the Box (OOTB) template” is an Infrastructure as Code (IaC) service provided by a cloud tool, service, or framework that a customer uses to create, modify, monitor, and/or remove cloud deployments from a virtual network of resources (e.g., virtual machines). For example, templates may allow deployment of infrastructure (e.g., cloud infrastructure) without the need to write and execute sequences of programming commands (or lines of code) to deploy the infrastructure. In some examples, a cloud resource template is a file that defines characteristics of a cloud infrastructure. For example, a cloud template may be a JavaScript Object Notation (JSON) file that defines what infrastructure will be used for deployment, configuration, and maintenance of the cloud resource associated with the template. In other examples, a user can select a template corresponding to a cloud account and use the template to manage resources associated with one or more cloud deployments of the cloud account. For example, the template can define policies for the target or desired states for resources of the cloud account and can be used to enforce the target or desired states on the resources of the cloud account. Such templates are referred to herein as “guardrails templates.”

Typically, users of a cloud account have to configure templates manually and/or via a third-party IaC tool, which can be costly, time consuming, and resource intensive. For example, users may need to manually review the description of each template to discern whether or not it will be suitable for their given use case. In some examples, users may have 50 or more templates to review. Therefore, the amount of templates to choose from and the time needed to review each template pose a risk selecting an incompatible or less favorable template. Additionally, a user may unknowingly apply an incompatible template to one or more cloud resources associated with a cloud account, which can cause the cloud account to operate at reduced efficiency.

Examples disclosed herein provide a template recommendation service to automatically determine at least one template for managing cloud resources associated with a given cloud account. Disclosed examples can determine a recommended template using Artificial Intelligence (AI) or Machine Learning (ML) algorithms. As used herein, a “recommended template” or an “output template” is an example template determined by the example template recommendation controller disclosed herein. Providing an example recommended template using examples disclosed herein decreases the amount of user intervention and user error in the template selection process. Additionally, examples disclosed herein determine which template can be implemented and/or enforced as target or desired states for cloud resources associated with a cloud account. For example, a user can enforce a recommended template on the cloud account to ensure cloud based resources of the cloud deployment adhere to policies set forth in the recommended template. As used herein, “policies” or “policy frameworks” are high-level rules, such as Center for Internet Security (CIS) benchmarks, Payment Card Industry (PCI) Data Security Standards, and so on, for settings (e.g., security settings, cost settings, performance settings, and/or networking settings) to be enforced on cloud resources. These policies include preventative guardrails and detective guardrails in the form of idempotent (IDEM) files. In some examples, a recommended template may not include policies. Accordingly, disclosed examples can encode policies in the recommended template, and enforce the policies set forth in the recommended template.

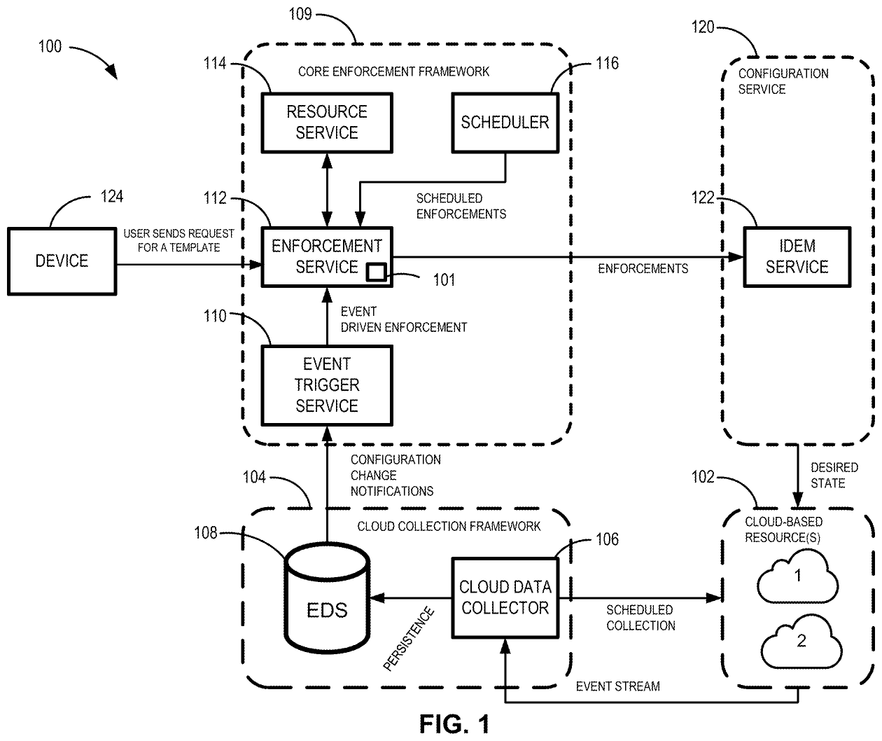

FIG. 1 is a schematic block diagram of an example environment 100 in which example template recommendation controller 101, to determine an example template to enforce target states on an example cloud account, can be implemented. In the illustrated example of FIG. 1, aspects and/or components of the environment 100 function as a system that manages operations and usage of example cloud-based resource(s) 102. The management of the operations can pertain to configuring settings, managing resource usage and/or managing access of the cloud-based resource(s) 102. The example architecture shown in the example of FIG. 1 is only an example and any appropriate other architecture, network, control scheme, communication and/or data topology can be implemented instead.

According to examples disclosed herein, an example cloud collection framework 104 includes an example cloud data collector 106 to coordinate and communicate with the cloud-based resource(s) 102. To that end, the example cloud data collector 106 can extract, receive and/or query information (e.g., components, metadata, services, service information) from the cloud-based resource(s) 102. In this example, the cloud data collector 106 can request and/or direct the cloud-based resource(s) 102 to provide information related to: (1) accounts utilizing the cloud-based resource(s) 102, (2) at least one configuration of the cloud-based resource(s) 102 and/or (3) services of the cloud-based resource(s) 102. The request by the cloud data collector 106 to the cloud-based resource(s) 102 can be driven by an occurrence of an event or performed on periodic or aperiodic timeframes and/or on a schedule. According to examples disclosed herein, the cloud-based resource(s) 102 provide(s) data, requested changes, configuration information and/or updates associated with the cloud-based resource(s) 102 to the cloud data collector 106 in response to a query from the cloud data collector 106 or without receiving a query from the cloud data collector 106. In some examples, the aforementioned data and/or updates provided to the cloud data collector 106 can include changes of a configuration of the cloud-based resource(s) 102 and/or operational data of the cloud-based resource(s) 102.

In this example, the aforementioned cloud collection framework 104 also includes an example entity data service (EDS) 108. The example EDS 108 can be implemented as a database, data store, database manager and/or database framework to store and/or collect data associated with the cloud-based resource(s) 102. The example EDS 108 stores entity data of the cloud-based resource(s) 102 in a normalized form (e.g., as a centralized repository). According to examples disclosed herein, the EDS 108 can provide any requested or proposed configuration change request to a core enforcement framework 109 which, in turn, includes an example event trigger service 110, an example enforcement service 112 that implements the aforementioned example template recommendation controller 101, an example resource service 114 and an example scheduler 116. For example, when an event occurs, such as a rule change and/or a configuration change corresponding to the cloud-based resource(s) 102, a notification from the EDS 108 is provided to the event trigger service 110.

The event trigger service 110 of the illustrated example is implemented to direct enforcement, configuration changes and/or access to services (e.g., microservices) of the cloud-based resource(s) 102. The example event trigger service 110 can map a configuration change event to a desired state of the cloud service(s). Accordingly, the example event trigger service 110 can direct control, usage and/or configuration of the cloud-based resource(s) 102 via (or in conjunction with) the aforementioned enforcement service 112. In this example, the event trigger service 110 provides requests and/or commands pertaining to event-driven enforcement of the cloud-based resource(s) 102 to the enforcement service 112. In some examples, the event trigger service 110 manages and/or directs changes to key value data stores. In some examples, the event trigger service 110 can utilize and/or implement a Kubernetes cluster.

The example enforcement service 112 determines, manages and provides enforcements (e.g., configuration changes, access changes, resource usage instructions, a desired state change, etc.) with respect to the cloud-based resource(s) 102 to a configuration service 120 based on the event-driven enforcements and/or instructions received from the event trigger service 110. Additionally or alternatively, notifications (e.g., configuration change notifications), enforcements and/or instructions received from the resource service 114 and the scheduler 116 cause the enforcement service 112 to provide enforcements to the configuration service 120. In turn, the enforcements provided to the configuration service 120 are subsequently provided to the cloud-based resource(s) 102 as desired state changes (e.g., desired state change instructions or directives).

In this example, the resource service 114 stores and/or manages operational data and/or settings of the cloud-based resource(s) 102. In this example, the resource service 114 contains, analyzes and/or manages metadata of the cloud-based resource(s) 102 that is utilized to manage the cloud-based resource(s) 102. In particular, the metadata corresponds to settings, access information and/or configurations of the cloud-based resource(s) 102, for example.

In some examples, the aforementioned scheduler 116 directs and/or manages scheduled implementations, configuration changes, enforcements and/or updates (e.g., periodic updates) of the cloud-based resource(s) 102 via the example enforcement service 112 and the configuration service 120. For example, the scheduler 116 can schedule the enforcement service 112 to perform scheduled enforcements of the configuration service 120 which, in turn, controls and/or directs a desired state of the cloud-based resource(s) 102.

To control, manage, enforce and/or direct operation of the cloud-based resource(s) 102, as mentioned above, the example enforcement service 112 provides the enforcements to the configuration service 120. In this example, the configuration service 120 includes an IDEM service 122 that is distinct from the core enforcement framework 109 and, thus, the enforcement service 112. However, the IDEM service 122 can be integrated with the enforcement service 112 and/or the core enforcement framework 109 in other examples. In the illustrated example of FIG. 1, the IDEM service 122 is an implementation/provisioning engine that implements desired state changes with respect to the cloud-based resource(s) 102. In other words, the IDEM service 122 controls a desired state of the cloud-based resource(s) 102 based on enforcements provided from the enforcement service 112. While the example template recommendation controller 101 is shown implemented in the example enforcement service 112, additionally or alternatively, the template recommendation controller 101 can be implemented in the resource service 114 and/or the scheduler 116.

In this example, the environment 100 includes an example device 124 to receive (e.g., access) user requests for a template. For example, the device 124 can include one or more input devices (e.g., keyboard, pointer device, touchscreen, etc.) or one or more output devices (e.g., display screen, speaker, headset, etc.). In this example, the user can be a customer or an end user associated with the cloud account providing the cloud-based resource(s) 102. The user can provide an input to the example enforcement service 112 to request a template for use with the cloud-based resource(s) 102. For example, the user can provide parameters and/or attributes to include in the example template and in any cloud resources subsequently generated by the output template. When the user provides such example inputs to the enforcement service 112, the enforcement service 112 can trigger the template recommendation controller 101 to determine (e.g., output) a recommended template. Then, the enforcement service 112 can apply the policy rules defined in the recommended templates to the cloud accounts such that the target or desired state of the accounts adhere to policies defined in the templates. Further, the example enforcement service 112 can continuously monitor the cloud accounts and resolve drifts relative to the target states. As used herein, “drift” refers to deviations of resource states relative to the established policies. In some examples, to keep cloud accounts compliant and ensure that drifts do not occur, the enforcement service 112 can enforce the policies on existing deployments on a recurring schedule. Thus, templates disclosed herein can ensure that cloud accounts comply with policies.

As mentioned above, any appropriate data topology, architecture and/or structure can be implemented instead. Further, any of the aforementioned aspects and/or elements described in connection with FIG. 1 can be combined or separated as appropriate. Further, while examples disclosed herein are shown in the context of cloud resources, examples disclosed herein can be implemented in conjunction with any appropriate distributed and/or shared computing resource system.

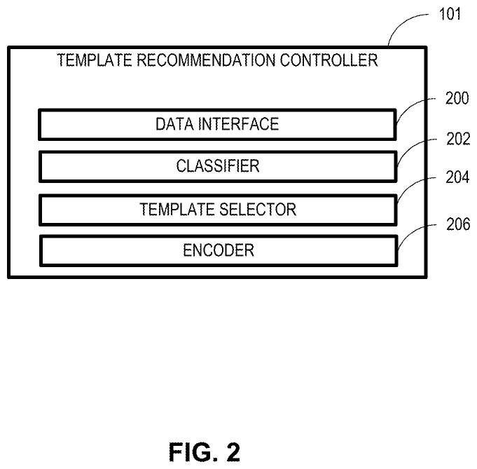

FIG. 2 is a block diagram of an example implementation of the template recommendation controller 101 of FIG. 1 to determine an example template to enforce target states on an example cloud account. The example template recommendation controller 101 includes example data interface 200, example classifier 202, example template selector 204, and example encoder 206. The template recommendation controller 101 of FIG. 2 may be instantiated (e.g., creating an instance of, bring into being for any length of time, materialize, implement, etc.) by programmable circuitry such as a Central Processor Unit (CPU) executing first instructions. Additionally or alternatively, the template recommendation controller 101 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

The example data interface 200 accesses metadata corresponding to a cloud resource of a cloud account. For example, the data interface 200 can accesses metadata such as properties or characteristics a cloud environment (e.g., public cloud or private cloud) associated with the cloud-based resource(s) 102 and/or information about an example cloud provider of the cloud-based resource(s) 102. In other examples, the data interface 200 can access metadata from the cloud data collector 106 and/or the resource service 114. For example, the data interface 200 can access information related to accounts utilizing the cloud-based resource(s) 102, at least one configuration of the cloud-based resource(s) 102 and/or services of the cloud-based resource(s) 102 from the cloud data collector 106. Additionally or alternatively, the example data interface 200 can access metadata corresponding to settings, access information and/or configurations of the cloud-based resource(s) 102 from the resource service 114.

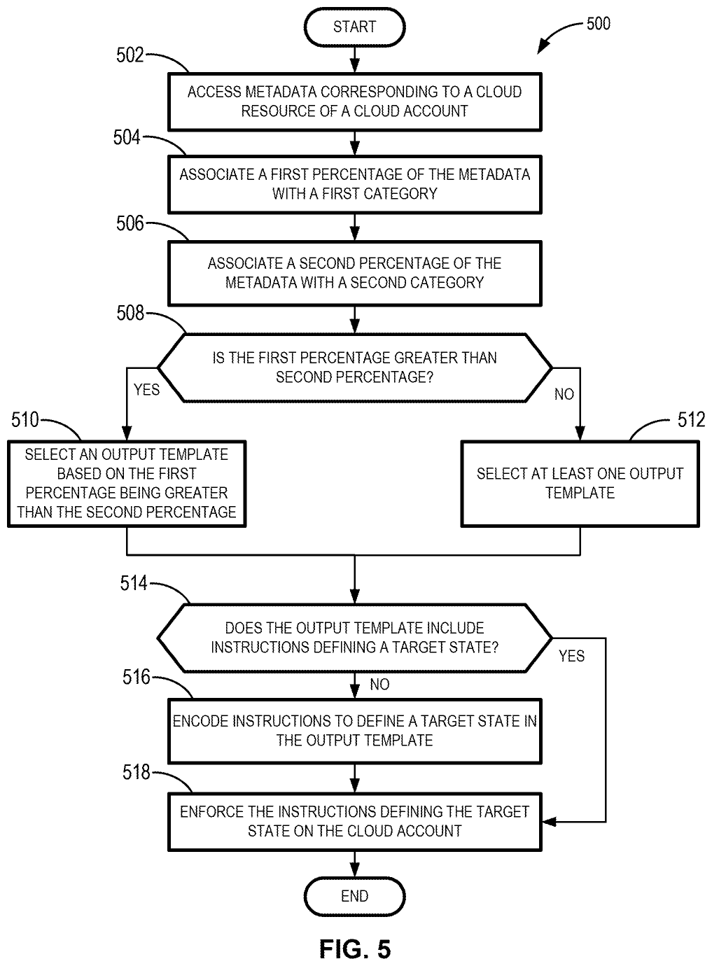

In some examples, the data interface 200 can access metadata corresponding to user inputs (e.g., user requests) for an example template. For example, the data interface 200 can access a first portion of the metadata indicating that a first user requested a template that included instructions to assign an authorization level (e.g., restricted, unrestricted, etc.) to a second user. The example data interface 200 can access a second portion of the metadata indicating that the user profile of the first user includes a restricted authorization level. The example data interface 200 can access a third portion of the metadata indicating that the cloud resource is deployed on a private cloud. The example data interface 200 can access a fourth portion of the metadata indicating that the user profile of the first user is associated with a certain cost center within a group or line of business. In some examples, the data interface 200 is instantiated by programmable circuitry executing data interfacing instructions and/or configured to perform operations such as those represented by the flowchart of FIG. 5.

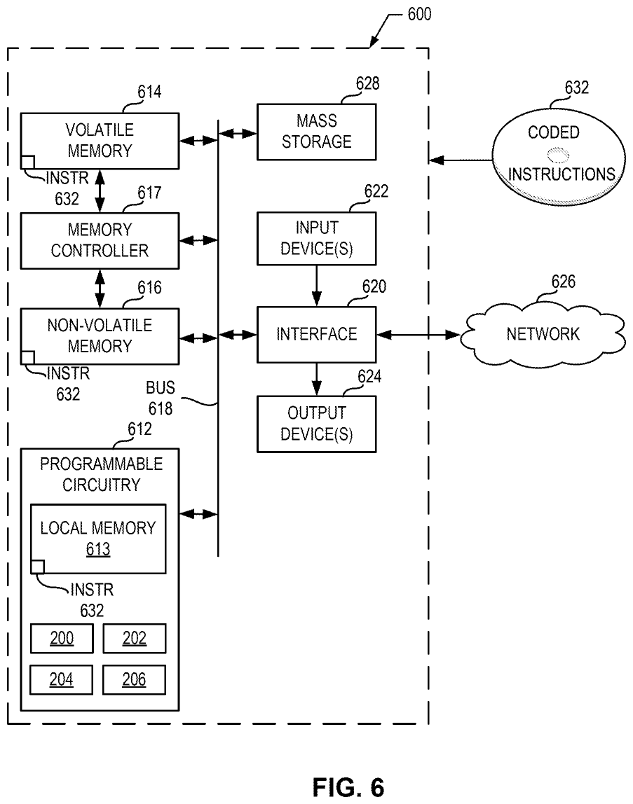

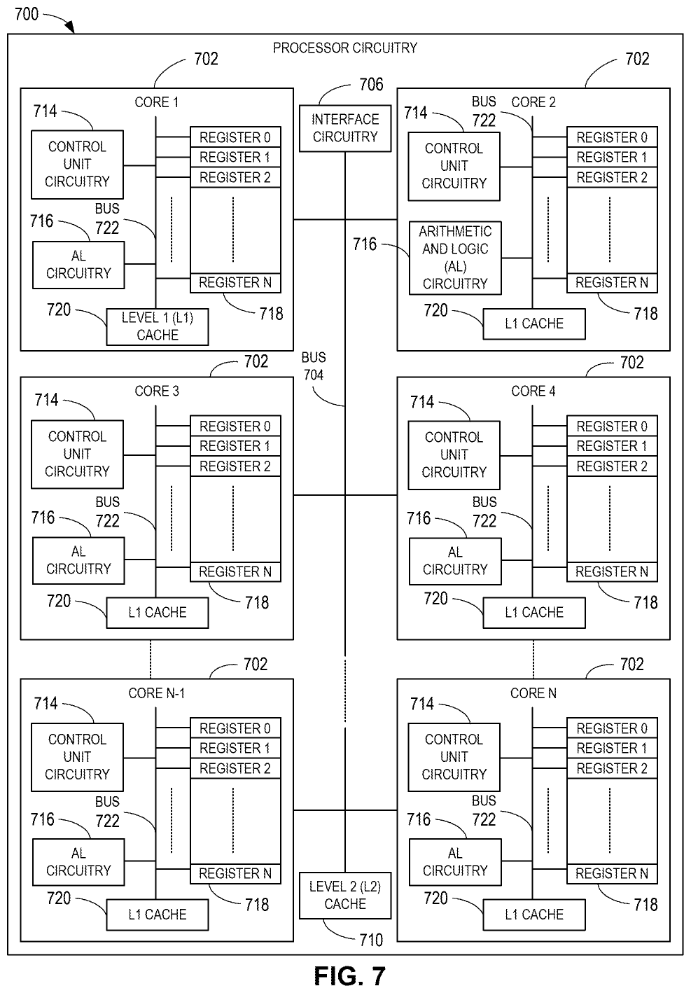

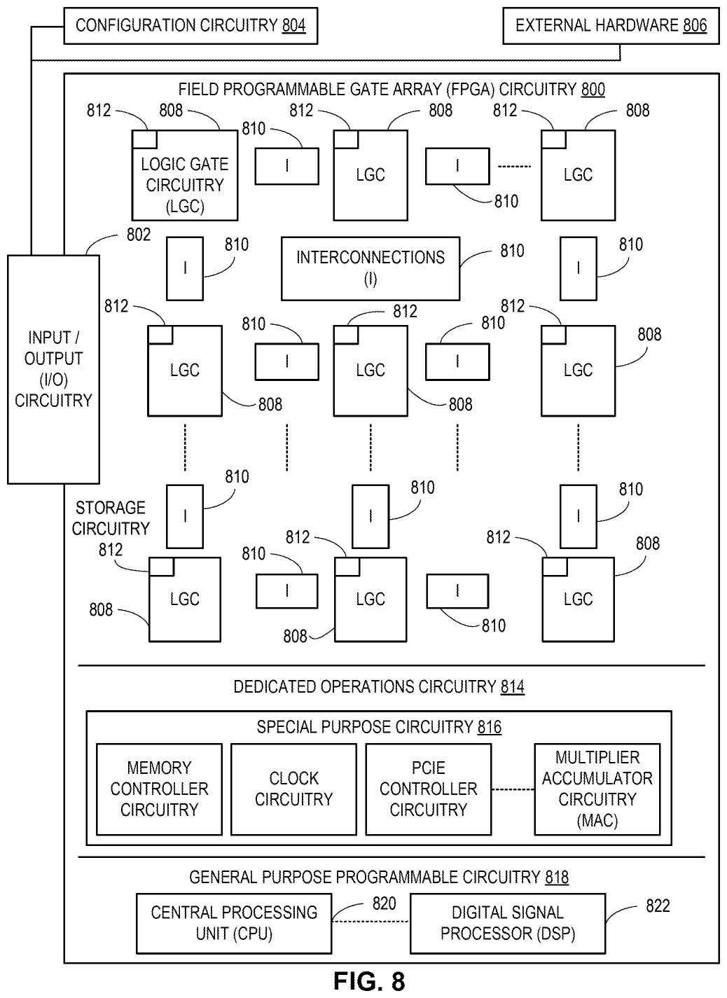

In some examples, the template recommendation controller 101 includes means for accessing metadata. For example, the means for accessing may be implemented by data interface circuitry such as the data interface 200. In some examples, the example data interface 200 may be instantiated by programmable circuitry such as the example programmable circuitry 612 of FIG. 6. For instance, the example data interface 200 may be instantiated by the example microprocessor 700 of FIG. 7 executing machine executable instructions such as those implemented by at least block 502 of FIG. 5. In some examples, example data interface 200 may be instantiated by hardware logic circuitry, which may be implemented by an ASIC, XPU, or the FPGA circuitry 800 of FIG. 8 configured and/or structured to perform operations corresponding to the machine readable instructions. Additionally or alternatively, the example data interface 200 may be instantiated by any other combination of hardware, software, and/or firmware. For example, the example data interface 200 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example classifier 202 can associate (e.g., classify, categorize, etc.) the metadata with categories (e.g., classes). In some examples, the classifier 202 can associate the metadata with categories via an AI/ML algorithm (e.g., Naive Bayes). For example, the classifier 202 can associate the metadata with a security category, a networking category, a performance category, or a cost category. The example security category can include metadata pertaining to protection of the cloud resource, such as firewalls, access/authorization requests, sensitive/confidential data, role assignments, a private network associated with the cloud resource, etc. The example networking category can include metadata pertaining to an example network infrastructure connecting the cloud resource to the Internet, an example network infrastructure connecting the user of the cloud resource to an example third-party customer, bandwidth of the example network, etc. The example performance category can include metadata pertaining to file storage performance, network performance, application performance and/or diagnostic solutions to file storage performance, network performance, application performance, etc. The example cost category can include metadata pertaining to the subscription of the cloud account, a cost analysis (e.g., spending, budgeting, etc.) associated with usage of the cloud resource, a cost center associated with a user of the cloud resource, etc.

In some examples, the classifier 202 can associate the first portion of the metadata (e.g., indicating that a first user requested a template including instructions to assign an authorization level to a second user) and the second portion of the metadata (e.g., the restricted authorization level of the first user) with the security category because authorization levels pertain to data protection, access requests, etc. Further, the example classifier 202 can associate the third portion (e.g., a deployment of the cloud resource on a private cloud) with the security category because a private cloud indicates the cloud resource may interact with confidential data. Alternatively, the example classifier 202 can associate the fourth portion of the metadata (e.g., the cost center associated with the first user) with the cost category.

In some examples, the classifier 202 can determine percentages (e.g., portions) of the metadata that correspond to the different categories. For example, the classifier 202 can determine that 75% of the metadata is associated with the security category (e.g., the first, second, and third portions of the four total portions of the metadata). Additionally, the example classifier 202 can determine that 25% of the metadata is associated with the cost category (e.g., the fourth portion of the four total portions of the metadata). In some examples, the classifier 202 is instantiated by programmable circuitry executing classification instructions and/or configured to perform operations such as those represented by the flowchart of FIG. 5.

In some examples, the template recommendation controller 101 includes means for classifying metadata. For example, the means for classifying may be implemented by classifier circuitry such as the example classifier 202. In some examples, the classifier 202 may be instantiated by programmable circuitry such as the example programmable circuitry 612 of FIG. 6. For instance, the classifier 202 may be instantiated by the example microprocessor 700 of FIG. 7 executing machine executable instructions such as those implemented by at least blocks 504, 506 of FIG. 5. In some examples, the classifier 202 may be instantiated by hardware logic circuitry, which may be implemented by an ASIC, XPU, or the FPGA circuitry 800 of FIG. 8 configured and/or structured to perform operations corresponding to the machine readable instructions. Additionally or alternatively, the classifier 202 may be instantiated by any other combination of hardware, software, and/or firmware. For example, the classifier 202 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example template selector 204 determines an example template (e.g., output template) based on the first and second percentages. In some examples, the template selector 204 determines an output template based on a first percentage of the classified metadata being greater than a second percentage of the classified metadata. Alternatively, the template selector 204 can determine an output template based on the second percentage being greater than the first percentage. As such, the example template selector 204 can compare the first percentage to the second percentage.

In some examples, when the first percentage of the metadata associated with the first category (e.g., 75% of the metadata associated with the security category) is greater than the second percentage of the metadata associated with the second category (e.g., 25% of the metadata associated with the cost category), the template selector 204 determines an output template associated with the first category (e.g., the security category). In other words, the example template selector 204 can determine an output template aligned with the needs and/or goals of a user. If the example metadata associated with the user, the user request, the requested template, etc. indicates information pertaining to security, the template selector 204 can determine a security-type template (which is more likely to be applicable than a cost-type template). In some examples, the template selector 204 can determine an output template that includes example instructions to define a target state or a desired state to be enforced on the cloud account. In other examples, the template selector 204 can determine an output template that may not include such instructions to define a target state or a desired state to be enforced on the cloud account. In some examples, the template selector 204 is instantiated by programmable circuitry executing determination instructions and/or configured to perform operations such as those represented by the flowchart of FIG. 5.

In some examples, the template recommendation controller 101 includes means for determining an example template. For example, the means for determining may be implemented by example template selector circuitry such as the example template selector 204. In some examples, the template selector 204 may be instantiated by programmable circuitry such as the example programmable circuitry 612 of FIG. 6. For instance, the template selector 204 may be instantiated by the example microprocessor 700 of FIG. 7 executing machine executable instructions such as those implemented by at least blocks 508, 510, 512 of FIG. 5. In some examples, the template selector 204 may be instantiated by hardware logic circuitry, which may be implemented by an ASIC, XPU, or the FPGA circuitry 800 of FIG. 8 configured and/or structured to perform operations corresponding to the machine readable instructions. Additionally or alternatively, the template selector 204 may be instantiated by any other combination of hardware, software, and/or firmware. For example, the template selector 204 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example encoder 206 can encode (e.g., generate) instructions to include in an example output template to define a target or desired state for the example cloud account. For example, when the template selector 204 determines an output template that may not include instructions to define a target or desired state on the example cloud account, the encoder 206 can generate such instructions. Further, the example encoder 206 can encode these example instructions in the output template. Accordingly, when the user accesses the template to modify or create the cloud-based resource(s) 102, then the example cloud-based resource(s) 102 will be subject to the target state defined by the instructions in the output template. In some examples, the encoder 206 is instantiated by programmable circuitry executing encoding instructions and/or configured to perform operations such as those represented by the flowchart of FIG. 5.

In some examples, the template recommendation controller 101 includes means for encoding instructions. For example, the means for encoding may be implemented by encoder circuitry such as the example encoder 206. In some examples, the encoder 206 may be instantiated by programmable circuitry such as the example programmable circuitry 612 of FIG. 6. For instance, the encoder 206 may be instantiated by the example microprocessor 700 of FIG. 7 executing machine executable instructions such as those implemented by at least blocks 514, 516 of FIG. 5. In some examples, the encoder 206 may be instantiated by hardware logic circuitry, which may be implemented by an ASIC, XPU, or the FPGA circuitry 800 of FIG. 8 configured and/or structured to perform operations corresponding to the machine readable instructions. Additionally or alternatively, the encoder 206 may be instantiated by any other combination of hardware, software, and/or firmware. For example, the encoder 206 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

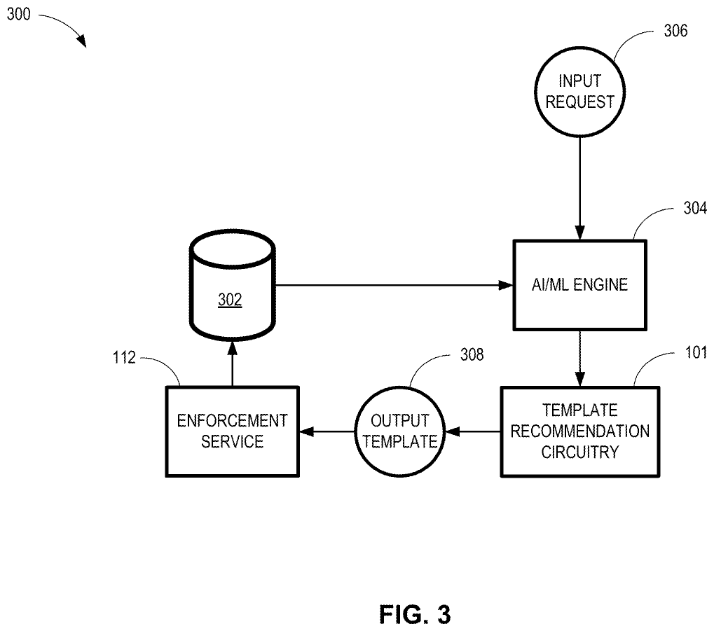

FIG. 3 illustrates an example process flow 300 to execute the example template recommendation controller 101 of FIGS. 1 and 2. The example process flow 300 includes the example template recommendation controller 101, the example enforcement service 112, an example data lake (e.g., a super collider data lake) 302, an example AI/ML engine 304, an example input request 306, and an example output template 308. The example process flow 300 begins at the example data lake 302. The example data lake 302 includes metadata corresponding to the cloud-based resource(s) 102 (FIG. 1) of an example cloud account. The example data lake 302 may be communicatively coupled to the data interface 200 (FIG. 2). As such, the example data interface 200 can transmit the first, second, third, and fourth example portions of the metadata to the data lake 302 (e.g., for storage). Further, the example data lake 302 stores example templates. In some examples, the data lake 302 stores templates according to category. For example, the data lake 302 can store security-type templates (e.g., Azure-Role Assignment Template, AWS-Member Account Template, AWS-Landing Zone Template, etc.), networking-type templates (e.g., Google Cloud-Router Template, AWS-Elastic Load Balancing Template, etc.), cost-type templates (e.g., Azure-Subscription Template, Azure-Resource Group Template, Azure-Budget Template, Google Cloud-Project Factory Template, etc.), and performance-type templates (e.g., Azure-Traffic Manager Template, Google Cloud-Health Check Template, etc.).

The example AI/ML engine 304 can access the example metadata stored in the data lake 302. In some examples, the classifier 202 (FIG. 2) implements the AI/ML engine 304 to associate the metadata into the example categories. For example, the AI/ML engine 304 may process the metadata (e.g., training data) to generate an example output template (e.g., output data) based on patterns and/or associations previously learned by the model via a training process. For example, the AI/ML engine 304 may be trained with data to recognize patterns and/or associations and apply such patterns and/or associations when processing input data such that other input(s) result in output(s) consistent with the recognized patterns and/or associations.

Many different types of machine learning models and/or machine learning architectures exist. In the example of FIG. 3, a Naive Bayes algorithm is used. A Naive Bayes algorithm is a probabilistic classifier that determines the probability or likelihood of an output belonging to a category/classification based on previous patterns of inputs and outputs. However, other types of machine learning models could additionally or alternatively be used such as logistic regression.

In FIG. 3, the example AI/ML engine 304 can be trained using the metadata stored in the data lake 302. Accordingly, the metadata stored in the data lake 302 may be referred to as training data, a training dataset, etc. The example AI/ML engine 304 associates the metadata into at least one of the security category, the cost category, the performance category, or the networking category. After training is complete, the example AI/ML engine 304 is deployed for use as an executable construct that processes an input and provides an output based on the network of connections and associations defined in the AI/ML engine 304.

The example AI/ML engine 304 can process the input request (e.g., unclassified input) 306. In some examples, the input request 306 can include a request for an example template, metadata pertaining to a user triggering the request, metadata pertaining to the cloud-based resource(s) 102, metadata pertaining to the cloud provider of the cloud-based resource(s) 102, etc. In this example, the input request 306 is a user request for an example template. Accordingly, the example data interface 200 accesses metadata (e.g., the first, second, third, and fourth portions of the metadata) corresponding to the input request 306.

The example AI/ML engine 304 can be implemented by the classifier 202 to associate the first, second, third, and fourth example portions of the metadata with the at least one of the security category, the cost category, the networking category, or the performance category. In particular, the example AI/ML engine 304 generates an output classification for each of the portions of the metadata based on what the AI/ML engine 304 learned from the training process (e.g., by executing the model to apply the learned patterns and/or associations to the live data). For example, the AI/ML engine 304 associates the first portion of the metadata (e.g., indicating that a first user requested a template including instructions to assign an authorization level to a second user) and the second portion of the metadata (e.g., the restricted authorization level of the first user) with the security category because the AI/ML engine 304 learned during training that authorization levels pertain to security-type transactions such as data protection, access requests, etc. Further, the example AI/ML engine 304 associates the third portion (e.g., deployment of the cloud resource on a private cloud) with the security category because the AI/ML engine 304 learned during training that a private cloud indicates the cloud resource may interact with confidential data or other security-type transactions. Alternatively, the example AI/ML engine 304 associates the fourth portion of the metadata (e.g., the cost center associated with the first user) with the cost category because the AI/ML engine 304 learned during training that cost centers and other budgeting items relate to cost.

The example AI/ML engine 304 can transmit these associations to the classifier 202. Accordingly, the example classifier 202 can determine that 75% of the metadata is associated with the security category (e.g., the first, second, and third portions of the four total portions of the metadata). Additionally, the example classifier 202 can determine that 25% of the metadata is associated with the cost category (e.g., the fourth portion of the four total portions of the metadata).

The example template selector 204 determines the output template 308 based on the first and second percentages. In this example, the first percentage of the metadata associated with the security category is greater than the second percentage of the metadata associated with the cost category (e.g., 75%>25%). Thus, the example template selector 204 determines (e.g., recommends, provides, etc.) the output template 308 associated with the security category (e.g., the Azure-Role Assignment Template). In other words, the example template selector 204 can determine a security-type template as the output template 308 because the majority of the metadata indicates information pertaining to security (as opposed to cost).

The example output template 308 includes example instructions to define a target state or desired state to be enforced on the cloud account. In turn, the example enforcement service 112 can execute the instructions defined in the output template 308 in the cloud account such that the target or desired state of the account adheres to policies defined in the output template 308. Further, the example enforcement service 112 can continuously monitor the cloud account and resolve drifts relative to the target states. In some examples, the enforcement service 112 can store the input request 306, the first, second, third, and fourth example portions of the metadata, the output template 308, the output classifications from the AI/ML engine 304, etc., in the data lake 302. Then, the example data lake 302 can refine (e.g., update) the training dataset for the AI/ML engine 304 as the AI/ML engine 304 prepares for additional input request(s) to process.

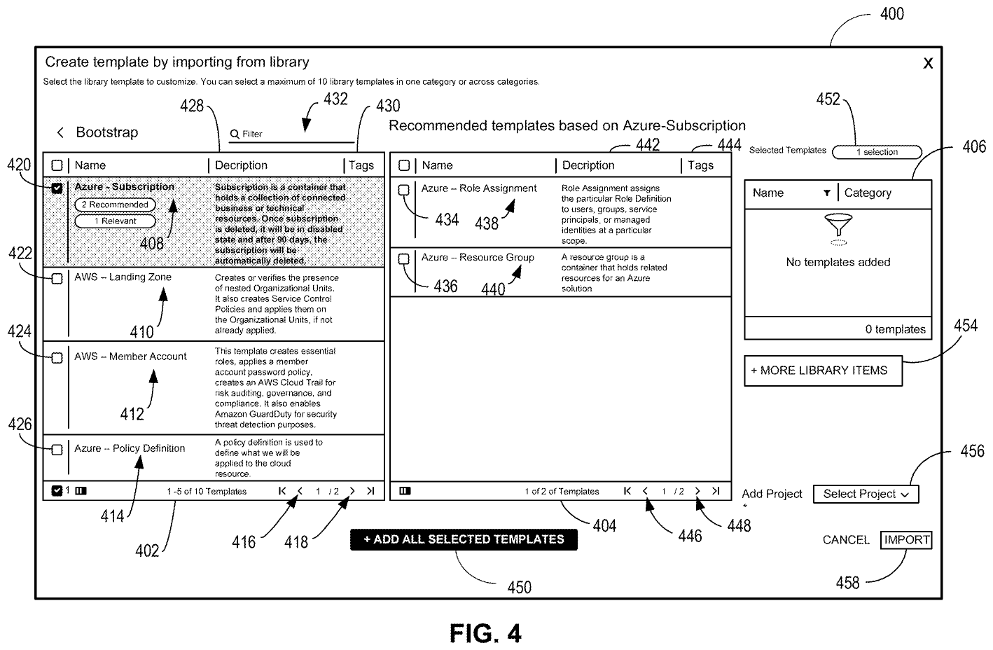

FIG. 4 illustrates an example user interface 400 to determine at least one example output template. The example user interface 400 includes a first example region 402, a second example region 404, and a third example region 406. The first example region 402 includes a list of example templates 408, 410, 412, 414. Although four example templates 408, 410, 412, 414 are shown in the first region 402, in other examples, there may be any number of example templates in the first region 402. For example, the first region 402 may include a scroll (e.g., pan) function to view additional templates listed below the templates 408, 410, 412, 414. In other examples, example arrow buttons 416, 418 can switch or turn a page in the first region 402 to display additional templates.

The first example region 402 includes example selection boxes 420, 422, 424, 426 for a user to select one of the templates 408, 410, 412, 414. In this example, the selection boxes 420, 422, 424, 426 are positioned on a first side of the list of the templates 408, 410, 412, 414. Further, an example description column 428 is positioned on a second side of the list of the templates 408, 410, 412, 414. The example description column 428 includes descriptions that correspond to the templates 408, 410, 412, 414. The example descriptions of the templates 408, 410, 412, 414 are included in FIG. 4 for purposes of explanation and are not limiting to the implementation of the example templates 408, 410, 412, 414 in the teachings disclosed herein. As shown in FIG. 4, the example template 408 is an Azure-Subscription Template including a container that holds a collection of connected business or technical resources. In some examples, once a subscription is deleted, it will be in a disabled state and after a number of days (e.g., 90 days), the subscription will be automatically deleted. The example template 410 is an AWS-Landing Zone Template that creates or verifies the presence of nested Organizational Units. Additionally, the AWS-Landing Zone Template creates Service Control Policies and applies them on the Organizational Units, if not already applied. The example template 412 is an AWS-Member Account Template that creates essential roles, applies member account password policy, creates an AWS Cloud Trail for risk auditing, governance, and compliance. Further, the AWS-Member Account Template enables Amazon GuardDuty for security threat detection purposes. The example template 414 is an Azure-Policy Definition Template that can define policies associated with the cloud resource.

In some examples, the templates 408, 410, 412, 414 may include a tag (e.g., label, association, etc.). The first example region 402 includes an example tag column 430 adjacent to the description column 428. Accordingly, at least one example tag can be positioned in the respective rows of each of the templates 408, 410, 412, 414. In some examples, the templates 408, 410, 412, 414 can be filtered by name, description, and/or tag. For example, a filter can be provided in an example filter input field 432 with words and/or phrases (e.g., “subscription,” “role,” “policy definition,” etc.) to refine (e.g., narrow) the search for one of the templates 408, 410, 412, 414.

Similarly, the second example region 404 includes example selection boxes 434, 436, example templates 438, 440, an example description column 442, and an example tag column 444. In this example, the second region 404 includes the two example templates 438, 440. However, the second example region 404 can include any number of templates. As shown in FIG. 4, the example template 438 is an Azure-Role Assignment Template that can assign the particular role definition to users, groups, service principals, or managed identities as a particular scope. The example template 440 is an Azure-Resource Group Template that creates a resource group associated with the subscription to the cloud account as a container that holds related resources for an Azure solution. The second example region 404 is responsive to inputs from the first region 402. For example, the second example region 404 can change (e.g., increase in the number of templates displayed, decrease in the number of templates displayed, display different kinds of templates, display different descriptions of templates, etc.) based on selections or inputs made in the first region 402. In some examples, the second region 404 includes example buttons 446, 448 that enable a user to switch or turn a page in the second region 404 to display additional templates.

The example device 124 of FIG. 1 may display the user interface 400. As such, a user can view, monitor, and/or manipulate the example user interface 400 via the device 124. For example, the device 124 can include a keyboard, pointer device, touchscreen, etc., for a user to navigate the user interface 400. The user may access the example user interface 400 to request an example template (e.g., one of the templates 408, 410, 412, 414). In some examples, the templates 408, 410, 412, 414 provide framework (e.g. base) code such that a user can access the framework code and add (e.g., manually type or add) additional code to the framework code. In other words, the templates 408, 410, 412, 414 (and the templates 438, 440) are editable (e.g., adjustable, customizable, etc.). As shown in FIG. 4, the example templates 408, 410, 412, 414, 438, 440 may be referred to as “library templates.” A user can import at least one of the library templates for customization.

In FIG. 4, the example selection box 420 is shaded, indicating that the user has selected the template 408 (e.g., Azure-Subscription Template) for customization. The selection of the box 420 and the template 408 can represent an example user input (e.g., the input request 306). As such, the example data interface 200 can access metadata corresponding to the selection (e.g., input, request, etc.). As used herein, “selection metadata” refers to metadata associated with the template 408, the selection of the template 408, a user request or input for the template 408, etc. For example, the selection metadata can indicate that the user requested a template including instructions to create a subscription to cloud resources associated with the cloud account, identification information associated with the user (e.g., an authorization level associated with the user, a cost center associated with the user, a job title associated with the user, etc.), etc. Additionally, the example classifier 202 can associate the selection metadata as a request for a cost-type template because cost centers and other budgeting processes relate to cost. Further, the example user interface 400 includes a description that a user can select a maximum of 10 library templates in one category or across categories. In other examples, any number of the selection boxes 420, 422, 424, 426, any combination of the selection boxes 420, 422, 424, 426, or any maximum number of the selection boxes 420, 422, 424, 426 may be shaded/selected.

In some examples, the data interface 200 can access (e.g., record, track, etc.) activity metadata. In some examples, the activity metadata can indicate the intent, desires, goals, etc., of the user. As used herein, “activity metadata” refers to metadata associated with activity of the user such as a usage history with the cloud resource, searches or queries performed by the user prior to selecting one of the templates 408, 410, 412, 414, data pertaining to preferences of the user, etc. For example, if a first user had previously researched the role/authorization level of a second user, then the data interface 200 can record the search, the role/authorization level of the second user, the role/authorization level of the first user, etc., as activity metadata. Then, the example classifier 202 can associate the activity metadata with at least one of the security category, the cost category, the networking category, or the performance category. In some examples, the example classifier 202 can reference a stored pattern that indicates when previous users execute user activity regarding roles/authorization levels, then the activity metadata is associated with the security category. Therefore, the example classifier 202 has learned (e.g., via a training process such as the training described in connection with FIG. 3) that activity metadata can indicate the intent, desires, goals, etc., of the user.

The example template selector 204 selects at least one output template based on the output classifications determined by the classifier 202. In this example, the template selector 204 outputs the security-type template 438 (e.g., the Azure-Role Assignment Template 438) based on the classifier 202 associating the activity metadata with the security category. Further, the example template selector 204 outputs the cost-type template 440 (e.g., the Azure-Resource Group Template 440) based on the classifier 202 associating the selection metadata with the cost-type category.

In other examples, the template selector 204 can determine that the requested template (e.g., the Azure-Subscription Template 408) depends on (or is related to) other example templates. For example, the classifier 202 may have learned (e.g., via a training process) that previous users who request the Azure-Subscription Template 408 proceed to request the Azure-Role Assignment Template 438 and/or the Azure-Resource Group Template 440. Then, the example template selector 204 can determine that the Azure-Subscription Template 408 is related to the Azure-Role Assignment Template 438 and/or the Azure-Resource Group Template 440. As such, the template selector 204 can output the Azure-Role Assignment Template 438 and the Azure-Resource Group Template 440 as recommended templates. In some examples, the template selector 204 can output at least one relevant template. As used herein, a “relevant template” is an output template that is related to the requested template, but not related as much as the recommended templates. In the example of FIG. 4, the Azure-Role Assignment Template 438 and the Azure-Resource Group Template 440 are recommended templates.

In some examples, the user can select at least one of the templates 408, 410, 412, 414, 438, 440 to import and/or customize. As such, at least one of the selection boxes 420, 422, 424, 426, 434, 436 can be shaded (e.g., selected). Then, the user can select a first example button 450 to add selected ones of templates 408, 410, 412, 414, 438, 440 to the third example region 406. The third example region 406 can store (e.g., list, display, etc.) each of the selected ones of the templates 408, 410, 412, 414, 438, 440. An example selection field 452 can display a number of the selected ones of the templates 408, 410, 412, 414, 438, 440 (e.g., 1, 2, 5, etc.). Further, the third example region 406 can display a category (e.g., security category, cost category, performance category, networking category, etc.) associated with each of the selected ones of the templates 408, 410, 412, 414, 438, 440. In some examples, the user can select (e.g., or hover over) a second example button 454 to add more library items (e.g., library data, input data, etc.) in addition to the selected ones of the templates 408, 410, 412, 414, 438, 440. For example, if the selected ones of the templates 408, 410, 412, 414, 438, 440 do not include instructions to define a target state or a desired state to the cloud resource, then the user can add instructions from the library items to encode in at least one of the selected ones of the templates 408, 410, 412, 414, 438, 440 (e.g., via the encoder 206). In other examples, the selected ones of the templates 408, 410, 412, 414, 438, 440 may already include such instructions to define a target state or a desired state. Then, the example enforcement service 112 can execute the instructions defined in the selected ones of the templates 408, 410, 412, 414, 438, 440 such that the target state or desired state of the cloud account adheres to policies defined in the selected ones of the templates 408, 410, 412, 414, 438, 440.

Additionally, the user can determine an example project (e.g., a department associated with the user, a team name associated with the user, etc.) from an example drop-down list control 456 to assign the selected ones of the templates 408, 410, 412, 414, 438, 440. Then, the user may select a third example button 458 to import the selected ones of the templates 408, 410, 412, 414, 438, 440 and the additional library items to the cloud resource.

While an example manner of implementing the template recommendation controller 101 of FIG. 1 is illustrated in FIG. 2, one or more of the elements, processes, and/or devices illustrated in FIG. 2 may be combined, divided, re-arranged, omitted, eliminated, and/or implemented in any other way. Further, the example data interface 200, the example classifier 202, the example template selector 204, the example encoder 206 and/or, more generally, the example template recommendation controller 101 of FIG. 2, may be implemented by hardware alone or by hardware in combination with software and/or firmware. Thus, for example, any of the example data interface 200, example classifier 202, example template selector 204, example encoder 206, and/or, more generally, the example template recommendation controller 101, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example template recommendation controller 101 of FIG. 2 may include one or more elements, processes, and/or devices in addition to, or instead of, those illustrated in FIG. 2, and/or may include more than one of any or all of the illustrated elements, processes and devices.

An example flowchart representative of example machine readable instructions, which may be executed by programmable circuitry to implement and/or instantiate the template recommendation controller 101 of FIG. 2 and/or representative of example operations which may be performed by programmable circuitry to implement and/or instantiate the template recommendation controller 101 of FIG. 2, are shown in FIG. 5. The machine readable instructions may be one or more executable programs or portion(s) of one or more executable programs for execution by programmable circuitry such as the programmable circuitry 612 shown in the example processor platform 600 discussed below in connection with FIG. 6 and/or may be one or more function(s) or portion(s) of functions to be performed by the example programmable circuitry (e.g., an FPGA) discussed below in connection with FIGS. 7 and/or 8. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart illustrated in FIG. 5, many other methods of implementing the example template recommendation controller 101 may alternatively be used. For example, the order of execution of the blocks of the flowchart may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIG. 5 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 5 is a flowchart representative of example machine readable instructions and/or example operations 500 that may be executed, instantiated, and/or performed by programmable circuitry to determine an example output template. The example machine-readable instructions and/or the example operations 500 of FIG. 5 begin at block 502, at which the data interface 200 accesses metadata corresponding to an example cloud resource of an example cloud account. For example, the data interface 200 can access the first portion of the metadata (e.g., indicating that a first user requested a template that included instructions to assign an authorization level to a second user), the second portion of the metadata (e.g., indicating that the user profile of the first user includes a restricted authorization level), the third portion of the metadata (e.g., indicating that the cloud resource is deployed on a private cloud), and the fourth portion of the metadata (e.g., indicating that the user profile of the first user is associated with a specified/certain cost center). In some examples, the data interface 200 can access selection metadata corresponding to a user selection, user request, and/or user input (e.g., the selection of box 420, the input request 306, etc.) for a template. In other examples, the data interface 200 can access activity metadata (e.g., searches or queries performed by the user). In some examples, the data interface 200 can access metadata from at least one of the resource service 114, the cloud data collector 106, and/or the data lake 302.

At block 504, the example classifier 202 associates a first percentage of the example metadata with a first category. For example, the classifier 202 can associate the first portion of the metadata (e.g., indicating that a first user requested a template including instructions to assign an authorization level to a second user), the second portion of the metadata (e.g., the restricted authorization level of the first user) with the security category because authorization levels pertain to data protection, access requests, etc. Further, the example classifier 202 can associate the third portion (e.g., deployment of the cloud resource on a private cloud) with the security category because a private cloud indicates the cloud resource may interact with confidential data. The example classifier 202 can determine that 75% of the metadata is associated with the security category (e.g., ¾ portions of the metadata=75% of the metadata). In other examples, the classifier 202 can associate the activity metadata with the security category. In some examples, the classifier 202 implements the AI/ML engine 304 to associate the metadata with the security category.

At block 506, the example classifier 202 can associate a second percentage of the example metadata with a second category. For example, the classifier 202 can associate the fourth portion of the metadata (e.g., the cost center associated with the first user) with the cost category. As such, the classifier 202 can determine that 25% of the metadata is associated with the cost category (e.g., ¼ portion of the metadata=25% of the metadata). In other examples, the classifier 202 can associate the selection metadata with the cost category. In some examples, the classifier 202 implements the AI/ML engine 304 to associate the metadata with the cost category.

At block 508, the example template selector 204 determines whether the first percentage is greater than the second percentage. In some examples, when the first percentage is greater than the second percentage, control proceeds to block 510. For example, the template selector 204 can determine that the 75% of the metadata associated with the security category is greater than the 25% of the metadata associated with the cost category (e.g., 75%>25%).

Alternatively, when the first percentage is not greater than (e.g., it is less than or equal to) the second percentage, control proceeds to block 512. For example, if 40% of the metadata is associated with the first category (e.g., the networking category) and 60% of the metadata is associated with the second category (e.g., the performance category), then the template selector 204 can determine that the 60% of the metadata associated with the second category is greater than the 40% of the metadata associated with the first category (e.g., 40%<60%). As such, control proceeds to block 512. In other examples, the first percentage of the metadata associated with the first category may be approximately equal to (e.g., within 5%) the percentage of the metadata associated with the second category. For example, the template selector 204 can determine that the percentage of the metadata associated with the activity metadata is approximately equal to the percentage of the metadata associated with the selection data (e.g., 50%=50%). As such, control proceeds to block 512.

At block 510, the example template selector 204 selects an output template based on the first percentage being greater than the second percentage. For example, when the percentage of the metadata associated with the security category is greater than the percentage of the metadata associated with the cost category, then the template selector 204 can select a security-type template (e.g., the output template 308, the Azure-Role Assignment Template 438, etc.) as the output template.

At block 512, the example template selector 204 selects at least one output template. For example, the template selector 204 can select an example output template based on the second percentage being greater than the first percentage. For example, when the percentage of the metadata associated with the cost category is greater than the percentage of the metadata associated with the security category, then the template selector 204 can select a cost-type template (e.g., Azure—Budget Template) as the output template. In other examples, when the percentage of the metadata associated with the activity metadata is approximately equal to the percentage of the metadata associated with the selection metadata, then the template selector 204 can select the Azure—Role Assignment Template 438 and/or the Azure—Resource Manager Template 440 as the output templates.

At block 514, the example encoder 206 determines whether the example output template includes instructions defining a target state. If the example encoder 206 determines that the example output template does not include instructions defining a target state, then control proceeds to block 516. Alternatively, if the example encoder 206 determines that the example output template (e.g., the output template 308, the Azure-Role Assignment Template 438, the Azure-Resource Manager Template 440, etc.) includes instructions defining a target state, then control proceeds to block 518.

At block 516, the example encoder 206 encodes instructions to define a target state in the example output template.

At block 518, the example enforcement service 112 enforces the instructions defining the target state on the cloud account. For example, the enforcement service 112 enforces (e.g., executes) the instructions defined in the selected ones of the templates 408, 410, 412, 414, 438, 440 such that the target state or the desired state of the cloud account adheres to policies defined in the selected ones of the templates 408, 410, 412, 414, 438, 440. Then, the example instructions and/or operations 500 end.

FIG. 6 is a block diagram of an example programmable circuitry platform 600 structured to execute and/or instantiate the example machine-readable instructions and/or the example operations of FIG. 5 to implement the template recommendation controller 101 of FIG. 2. The programmable circuitry platform 600 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a gaming console, or any other type of computing and/or electronic device.

The programmable circuitry platform 600 of the illustrated example includes programmable circuitry 612. The programmable circuitry 612 of the illustrated example is hardware. For example, the programmable circuitry 612 can be implemented by one or more integrated circuits, logic circuits, FPGAs, microprocessors, CPUs, GPUs, DSPs, and/or microcontrollers from any desired family or manufacturer. The programmable circuitry 612 may be implemented by one or more semiconductor based (e.g., silicon based) devices. In this example, the programmable circuitry 612 implements the example data interface 200, the example classifier 202, the example template selector 204, and the example encoder 206.

The programmable circuitry 612 of the illustrated example includes a local memory 613 (e.g., a cache, registers, etc.). The programmable circuitry 612 of the illustrated example is in communication with main memory 614, 616, which includes a volatile memory 614 and a non-volatile memory 616, by a bus 618. The volatile memory 614 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 616 may be implemented by flash memory and/or any other desired type of memory device. Access to the main memory 614, 616 of the illustrated example is controlled by a memory controller 617. In some examples, the memory controller 617 may be implemented by one or more integrated circuits, logic circuits, microcontrollers from any desired family or manufacturer, or any other type of circuitry to manage the flow of data going to and from the main memory 614, 616.

The programmable circuitry platform 600 of the illustrated example also includes interface circuitry 620. The interface circuitry 620 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 622 are connected to the interface circuitry 620. The input device(s) 622 permit(s) a user (e.g., a human user, a machine user, etc.) to enter data and/or commands into the programmable circuitry 612. The input device(s) 622 can be implemented by, for example, an audio sensor, a microphone, a camera (still or video), a keyboard, a button, a mouse, a touchscreen, a trackpad, a trackball, an isopoint device, and/or a voice recognition system.

One or more output devices 624 are also connected to the interface circuitry 620 of the illustrated example. The output device(s) 624 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 620 of the illustrated example, thus, typically includes a graphics driver card, a graphics driver chip, and/or graphics processor circuitry such as a GPU.

The interface circuitry 620 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 626. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 600 of the illustrated example also includes one or more mass storage discs or devices 628 to store firmware, software, and/or data. Examples of such mass storage discs or devices 628 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 632, which may be implemented by the machine readable instructions of FIG. 5, may be stored in the mass storage device 628, in the volatile memory 614, in the non-volatile memory 616, and/or on at least one non-transitory computer readable storage medium such as a CD or DVD which may be removable.

FIG. 7 is a block diagram of an example implementation of the programmable circuitry 612 of FIG. 6. In this example, the programmable circuitry 612 of FIG. 6 is implemented by a microprocessor 700. For example, the microprocessor 700 may be a general-purpose microprocessor (e.g., general-purpose microprocessor circuitry). The microprocessor 700 executes some or all of the machine-readable instructions of the flowchart of FIG. 5 to effectively instantiate the circuitry of FIG. 2 as logic circuits to perform operations corresponding to those machine readable instructions. In some such examples, the circuitry of FIG. 2 is instantiated by the hardware circuits of the microprocessor 700 in combination with the machine-readable instructions. For example, the microprocessor 700 may be implemented by multi-core hardware circuitry such as a CPU, a DSP, a GPU, an XPU, etc. Although it may include any number of example cores 702 (e.g., 1 core), the microprocessor 700 of this example is a multi-core semiconductor device including N cores. The cores 702 of the microprocessor 700 may operate independently or may cooperate to execute machine readable instructions. For example, machine code corresponding to a firmware program, an embedded software program, or a software program may be executed by one of the cores 702 or may be executed by multiple ones of the cores 702 at the same or different times. In some examples, the machine code corresponding to the firmware program, the embedded software program, or the software program is split into threads and executed in parallel by two or more of the cores 702. The software program may correspond to a portion or all of the machine readable instructions and/or operations represented by the flowchart of FIG. 5.

The cores 702 may communicate by a first example bus 704. In some examples, the first bus 704 may be implemented by a communication bus to effectuate communication associated with one(s) of the cores 702. For example, the first bus 704 may be implemented by at least one of an Inter-Integrated Circuit (I2C) bus, a Serial Peripheral Interface (SPI) bus, a PCI bus, or a PCIe bus. Additionally or alternatively, the first bus 704 may be implemented by any other type of computing or electrical bus. The cores 702 may obtain data, instructions, and/or signals from one or more external devices by example interface circuitry 706. The cores 702 may output data, instructions, and/or signals to the one or more external devices by the interface circuitry 706. Although the cores 702 of this example include example local memory 720 (e.g., Level 1 (L1) cache that may be split into an L1 data cache and an L1 instruction cache), the microprocessor 700 also includes example shared memory 710 that may be shared by the cores (e.g., Level 2 (L2 cache)) for high-speed access to data and/or instructions. Data and/or instructions may be transferred (e.g., shared) by writing to and/or reading from the shared memory 710. The local memory 720 of each of the cores 702 and the shared memory 710 may be part of a hierarchy of storage devices including multiple levels of cache memory and the main memory (e.g., the main memory 614, 616 of FIG. 6). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 702 may be referred to as a CPU, DSP, GPU, etc., or any other type of hardware circuitry. Each core 702 includes control unit circuitry 714, arithmetic and logic (AL) circuitry (sometimes referred to as an ALU) 716, a plurality of registers 718, the local memory 720, and a second example bus 722. Other structures may be present. For example, each core 702 may include vector unit circuitry, single instruction multiple data (SIMD) unit circuitry, load/store unit (LSU) circuitry, branch/jump unit circuitry, floating-point unit (FPU) circuitry, etc. The control unit circuitry 714 includes semiconductor-based circuits structured to control (e.g., coordinate) data movement within the corresponding core 702. The AL circuitry 716 includes semiconductor-based circuits structured to perform one or more mathematic and/or logic operations on the data within the corresponding core 702. The AL circuitry 716 of some examples performs integer based operations. In other examples, the AL circuitry 716 also performs floating-point operations. In yet other examples, the AL circuitry 716 may include first AL circuitry that performs integer-based operations and second AL circuitry that performs floating-point operations. In some examples, the AL circuitry 716 may be referred to as an Arithmetic Logic Unit (ALU).

The registers 718 are semiconductor-based structures to store data and/or instructions such as results of one or more of the operations performed by the AL circuitry 716 of the corresponding core 702. For example, the registers 718 may include vector register(s), SIMD register(s), general-purpose register(s), flag register(s), segment register(s), machine-specific register(s), instruction pointer register(s), control register(s), debug register(s), memory management register(s), machine check register(s), etc. The registers 718 may be arranged in a bank as shown in FIG. 7. Alternatively, the registers 718 may be organized in any other arrangement, format, or structure, such as by being distributed throughout the core 702 to shorten access time. The second bus 722 may be implemented by at least one of an I2C bus, a SPI bus, a PCI bus, or a PCIe bus.

Each core 702 and/or, more generally, the microprocessor 700 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 700 is a semiconductor device fabricated to include many transistors interconnected to implement the structures described above in one or more integrated circuits (ICs) contained in one or more packages.

The microprocessor 700 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 700, in the same chip package as the microprocessor 700 and/or in one or more separate packages from the microprocessor 700.

FIG. 8 is a block diagram of another example implementation of the programmable circuitry 612 of FIG. 6. In this example, the programmable circuitry 612 is implemented by FPGA circuitry 800. For example, the FPGA circuitry 800 may be implemented by an FPGA. The FPGA circuitry 800 can be used, for example, to perform operations that could otherwise be performed by the example microprocessor 700 of FIG. 7 executing corresponding machine readable instructions. However, once configured, the FPGA circuitry 800 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 700 of FIG. 7 described above (which is a general purpose device that may be programmed to execute some or all of the machine readable instructions represented by the flowchart of FIG. 5 but whose interconnections and logic circuitry are fixed once fabricated), the FPGA circuitry 800 of the example of FIG. 8 includes interconnections and logic circuitry that may be configured, structured, programmed, and/or interconnected in different ways after fabrication to instantiate, for example, some or all of the operations/functions corresponding to the machine readable instructions represented by the flowchart of FIG. 5. In particular, the FPGA circuitry 800 may be thought of as an array of logic gates, interconnections, and switches. The switches can be programmed to change how the logic gates are interconnected by the interconnections, effectively forming one or more dedicated logic circuits (unless and until the FPGA circuitry 800 is reprogrammed). The configured logic circuits enable the logic gates to cooperate in different ways to perform different operations on data received by input circuitry. Those operations may correspond to some or all of the instructions (e.g., the software and/or firmware) represented by the flowchart of FIG. 5. As such, the FPGA circuitry 800 may be configured and/or structured to effectively instantiate some or all of the operations/functions corresponding to the machine readable instructions of the flowchart of FIG. 5 as dedicated logic circuits to perform the operations/functions corresponding to those software instructions in a dedicated manner analogous to an ASIC. Therefore, the FPGA circuitry 800 may perform the operations/functions corresponding to the some or all of the machine readable instructions of FIG. 5 faster than the general-purpose microprocessor can execute the same.

In the example of FIG. 8, the FPGA circuitry 800 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 800 of FIG. 8 may access and/or load the binary file to cause the FPGA circuitry 800 of FIG. 8 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 800 of FIG. 8 to cause configuration and/or structuring of the FPGA circuitry 800 of FIG. 8, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 800 of FIG. 8 may access and/or load the binary file to cause the FPGA circuitry 800 of FIG. 8 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 800 of FIG. 8 to cause configuration and/or structuring of the FPGA circuitry 800 of FIG. 8, or portion(s) thereof.

The FPGA circuitry 800 of FIG. 8, includes example input/output (I/O) circuitry 802 to obtain and/or output data to/from example configuration circuitry 804 and/or external hardware 806. For example, the configuration circuitry 804 may be implemented by interface circuitry that may obtain a binary file, which may be implemented by a bit stream, data, and/or machine-readable instructions, to configure the FPGA circuitry 800, or portion(s) thereof. In some such examples, the configuration circuitry 804 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 806 may be implemented by external hardware circuitry. For example, the external hardware 806 may be implemented by the microprocessor 700 of FIG. 7.

The FPGA circuitry 800 also includes an array of example logic gate circuitry 808, a plurality of example configurable interconnections 810, and example storage circuitry 812. The logic gate circuitry 808 and the configurable interconnections 810 are configurable to instantiate one or more operations/functions that may correspond to at least some of the machine readable instructions of FIG. 5 and/or other desired operations. The logic gate circuitry 808 shown in FIG. 8 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 808 to enable configuration of the electrical structures and/or the logic gates to form circuits to perform desired operations/functions. The logic gate circuitry 808 may include other electrical structures such as look-up tables (LUTs), registers (e.g., flip-flops or latches), multiplexers, etc.

The configurable interconnections 810 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 808 to program desired logic circuits.

The storage circuitry 812 of the illustrated example is structured to store result(s) of the one or more of the operations performed by corresponding logic gates. The storage circuitry 812 may be implemented by registers or the like. In the illustrated example, the storage circuitry 812 is distributed amongst the logic gate circuitry 808 to facilitate access and increase execution speed.

The example FPGA circuitry 800 of FIG. 8 also includes example dedicated operations circuitry 814. In this example, the dedicated operations circuitry 814 includes special purpose circuitry 816 that may be invoked to implement commonly used functions to avoid the need to program those functions in the field. Examples of such special purpose circuitry 816 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 800 may also include example general purpose programmable circuitry 818 such as an example CPU 820 and/or an example DSP 822. Other general purpose programmable circuitry 818 may additionally or alternatively be present such as a GPU, an XPU, etc., that can be programmed to perform other operations.

Although FIGS. 7 and 8 illustrate two example implementations of the programmable circuitry 612 of FIG. 6, many other approaches are contemplated. For example, FPGA circuitry may include an on-board CPU, such as one or more of the example CPU 820 of FIG. 7. Therefore, the programmable circuitry 612 of FIG. 6 may additionally be implemented by combining at least the example microprocessor 700 of FIG. 7 and the example FPGA circuitry 800 of FIG. 8. In some such hybrid examples, one or more cores 702 of FIG. 7 may execute a first portion of the machine readable instructions represented by the flowchart of FIG. 5 to perform first operation(s)/function(s), the FPGA circuitry 800 of FIG. 8 may be configured and/or structured to perform second operation(s)/function(s) corresponding to a second portion of the machine readable instructions represented by the flowchart of FIG. 5, and/or an ASIC may be configured and/or structured to perform third operation(s)/function(s) corresponding to a third portion of the machine readable instructions represented by the flowchart of FIG. 5.

It should be understood that some or all of the circuitry of FIG. 2 may, thus, be instantiated at the same or different times. For example, same and/or different portion(s) of the microprocessor 700 of FIG. 7 may be programmed to execute portion(s) of machine-readable instructions at the same and/or different times. In some examples, same and/or different portion(s) of the FPGA circuitry 800 of FIG. 8 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 700 of FIG. 7 may execute machine readable instructions in one or more threads executing concurrently and/or in series. In some examples, the FPGA circuitry 800 of FIG. 8 may be configured and/or structured to carry out operations/functions concurrently and/or in series. Moreover, in some examples, some or all of the circuitry of FIG. 2 may be implemented within one or more virtual machines and/or containers executing on the microprocessor 700 of FIG. 7.

In some examples, the programmable circuitry 612 of FIG. 6 may be in one or more packages. For example, the microprocessor 700 of FIG. 7 and/or the FPGA circuitry 800 of FIG. 8 may be in one or more packages. In some examples, an XPU may be implemented by the programmable circuitry 612 of FIG. 6, which may be in one or more packages. For example, the XPU may include a CPU (e.g., the microprocessor 700 of FIG. 7, the CPU 820 of FIG. 8, etc.) in one package, a DSP (e.g., the DSP 822 of FIG. 8) in another package, a GPU in yet another package, and an FPGA (e.g., the FPGA circuitry 800 of FIG. 8) in still yet another package.

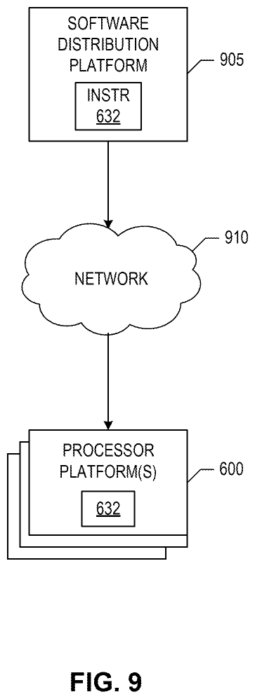

A block diagram illustrating an example software distribution platform 905 to distribute software such as the example machine readable instructions 632 of FIG. 6 to other hardware devices (e.g., hardware devices owned and/or operated by third parties from the owner and/or operator of the software distribution platform) is illustrated in FIG. 9. The example software distribution platform 905 may be implemented by any computer server, data facility, cloud service, etc., capable of storing and transmitting software to other computing devices. The third parties may be customers of the entity owning and/or operating the software distribution platform 905. For example, the entity that owns and/or operates the software distribution platform 905 may be a developer, a seller, and/or a licensor of software such as the example machine readable instructions 632 of FIG. 6. The third parties may be consumers, users, retailers, OEMs, etc., who purchase and/or license the software for use and/or re-sale and/or sub-licensing. In the illustrated example, the software distribution platform 905 includes one or more servers and one or more storage devices. The storage devices store the machine readable instructions 632, which may correspond to the example machine readable instructions of FIG. 5, as described above. The one or more servers of the example software distribution platform 905 are in communication with an example network 910, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third-party payment entity. The servers enable purchasers and/or licensors to download the machine readable instructions 632 from the software distribution platform 905. For example, the software, which may correspond to the example machine readable instructions of FIG. 5, may be downloaded to the example programmable circuitry platform 600, which is to execute the machine readable instructions 632 to implement the template recommendation controller 101. In some examples, one or more servers of the software distribution platform 905 periodically offer, transmit, and/or force updates to the software (e.g., the example machine readable instructions 632 of FIG. 6) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that provide template recommendation controller to automatically determine at least one template for managing cloud resources associated with a given cloud account. Disclosed examples can determine a recommended template using AI or ML algorithms. Providing an example recommended template using examples disclosed herein decreases the amount of user intervention and user error in the template selection process. Additionally, examples disclosed herein determine which template can be implemented and/or enforced as target or desired states for cloud resources associated with a cloud account. For example, a user can enforce a recommended template on the cloud account to ensure cloud based resources of the cloud deployment adhere to policies set forth in the recommended template. Disclosed examples can encode policies in the recommended template, and enforce the policies set forth in the recommended template. Disclosed systems, apparatus, articles of manufacture, and methods improve the efficiency of using a computing device by enabling end users to enforce target states or desired states on various cloud accounts associated with various cloud providers. Accordingly, cloud resources generated (or modified) by output templates disclosed herein are automatically enforced by the policies defined in the output templates. Disclosed systems, apparatus, articles of manufacture, and methods are accordingly directed to one or more improvement(s) in the operation of a machine such as a computer or other electronic and/or mechanical device.

Example 1 includes an apparatus comprising memory, first instructions, and programmable circuitry to be programmed by the first instructions to associate a first portion of metadata with a first category, the metadata corresponding to a cloud resource of a cloud account, associate a second portion of the metadata with a second category, and determine a template based on the first portion being greater than the second portion, the template associated with the first category, the template including second instructions to define a target state to be enforced on the cloud account.

Example 2 includes the apparatus of example 1, wherein the metadata indicates the cloud resource is deployed on at least one of a public cloud or a private cloud.

Example 3 includes the apparatus of example 1, wherein the first portion of the metadata includes usage history of the cloud resource, the usage history associated with a user of the cloud resource, the user associated with the cloud account.

Example 4 includes the apparatus of example 1, wherein the first category is a cost category, a performance category, a networking category, or a security category.

Example 5 includes the apparatus of example 1, wherein the first portion is a first percentage of the metadata, wherein the programmable circuitry is to associate the first percentage of the metadata with the first category via a machine learning (ML) algorithm.

Example 6 includes the apparatus of example 1, wherein the second instructions correspond to generating a subscription of the cloud resource, generating a role assignment of the cloud resource, or generating a member account of the cloud resource.

Example 7 includes the apparatus of example 1, wherein the template is an output template, the metadata corresponds to a requested template, the requested template requested based on an input from a user of the cloud resource, the user associated with the cloud account.

Example 8 includes a non-transitory machine readable storage medium comprising first instructions to cause programmable circuitry to at least associate a first portion of metadata with a first category, the metadata corresponding to a cloud resource of a cloud account, associate a second portion of the metadata with a second category, and determine a template based on the first portion being greater than the second portion, the template associated with the first category, the template including second instructions to define a target state to be enforced on the cloud account.

Example 9 includes the non-transitory machine readable storage medium of example 8, wherein the metadata indicates the cloud resource is deployed on at least one of a public cloud or a private cloud.

Example 10 includes the non-transitory machine readable storage medium of example 8, wherein the first portion of the metadata includes usage history of the cloud resource, the usage history associated with a user of the cloud resource, the user associated with the cloud account.

Example 11 includes the non-transitory machine readable storage medium of example 8, wherein the first category is a cost category, a performance category, a networking category, or a security category.

Example 12 includes the non-transitory machine readable storage medium of example 8, wherein the first instructions are to cause the programmable circuitry to associate the first portion of the metadata with the first category and associate the second portion of the metadata with the second category via a machine learning (ML) algorithm.

Example 13 includes the non-transitory machine readable storage medium of example 8, wherein the second instructions correspond to generating a subscription of the cloud resource, generating a role assignment of the cloud resource, or generating a member account of the cloud resource.

Example 14 includes the non-transitory machine readable storage medium of example 8, wherein the template is an output template, the metadata corresponds to a requested template, the requested template requested based on an input from a user of the cloud resource, the user associated with the cloud account.

Example 15 includes a method comprising associating, by executing first instructions with programmable circuitry, a first percentage of metadata with a first category, the metadata corresponding to a cloud resource of a cloud account, associating, by executing the first instructions with the programmable circuitry, a second percentage of the metadata with a second category, and determining, by executing the first instructions with the programmable circuitry, a template based on the first percentage being greater than the second percentage, the template associated with the first category, the template including second instructions to define a target state to be enforced on the cloud account.

Example 16 includes the method of example 15, wherein the metadata indicates the cloud resource is deployed on at least one of a public cloud or a private cloud.

Example 17 includes the method of example 15, wherein the first category is a cost category, a performance category, a networking category, or a security category.

Example 18 includes the method of example 15, further including associating the first percentage of the metadata with the first category via a machine learning (ML) algorithm.

Example 19 includes the method of example 15, wherein the second instructions correspond to generating a subscription of the cloud resource, generating a role assignment of the cloud resource, or generating a member account of the cloud resource.

Example 20 includes the method of example 15, wherein the template is an output template, the metadata corresponding to a requested template, the requested template requested based on an input from a user of the cloud resource, the user associated with the cloud account.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
memory;
first instructions; and
programmable circuitry to be programmed by the first instructions to:
associate a first portion of metadata with a first category, the metadata corresponding to a cloud resource of a cloud account;
associate a second portion of the metadata with a second category; and
determine a template based on the first portion being greater than the second portion, the template associated with the first category, the template including second instructions to define a target state to be enforced on the cloud account.

2. The apparatus of claim 1, wherein the metadata indicates the cloud resource is deployed on at least one of a public cloud or a private cloud.

3. The apparatus of claim 1, wherein the first portion of the metadata includes usage history of the cloud resource, the usage history associated with a user of the cloud resource, the user associated with the cloud account.

4. The apparatus of claim 1, wherein the first category is a cost category, a performance category, a networking category, or a security category.

5. The apparatus of claim 1, wherein the first portion is a first percentage of the metadata, wherein the programmable circuitry is to associate the first percentage of the metadata with the first category via a machine learning (ML) algorithm.

6. The apparatus of claim 1, wherein the second instructions correspond to generating a subscription of the cloud resource, generating a role assignment of the cloud resource, or generating a member account of the cloud resource.

7. The apparatus of claim 1, wherein the template is an output template, the metadata corresponds to a requested template, the requested template requested based on an input from a user of the cloud resource, the user associated with the cloud account.

8. A non-transitory machine readable storage medium comprising first instructions to cause programmable circuitry to at least:
associate a first portion of metadata with a first category, the metadata corresponding to a cloud resource of a cloud account;
associate a second portion of the metadata with a second category; and
determine a template based on the first portion being greater than the second portion, the template associated with the first category, the template including second instructions to define a target state to be enforced on the cloud account.

9. The non-transitory machine readable storage medium of claim 8, wherein the metadata indicates the cloud resource is deployed on at least one of a public cloud or a private cloud.

10. The non-transitory machine readable storage medium of claim 8, wherein the first portion of the metadata includes usage history of the cloud resource, the usage history associated with a user of the cloud resource, the user associated with the cloud account.

11. The non-transitory machine readable storage medium of claim 8, wherein the first category is a cost category, a performance category, a networking category, or a security category.

12. The non-transitory machine readable storage medium of claim 8, wherein the first instructions are to cause the programmable circuitry to associate the first portion of the metadata with the first category and associate the second portion of the metadata with the second category via a machine learning (ML) algorithm.

13. The non-transitory machine readable storage medium of claim 8, wherein the second instructions correspond to generating a subscription of the cloud resource, generating a role assignment of the cloud resource, or generating a member account of the cloud resource.

14. The non-transitory machine readable storage medium of claim 8, wherein the template is an output template, the metadata corresponds to a requested template, the requested template requested based on an input from a user of the cloud resource, the user associated with the cloud account.

15. A method comprising:
associating, by executing first instructions with programmable circuitry, a first percentage of metadata with a first category, the metadata corresponding to a cloud resource of a cloud account;
associating, by executing the first instructions with the programmable circuitry, a second percentage of the metadata with a second category; and
determining, by executing the first instructions with the programmable circuitry, a template based on the first percentage being greater than the second percentage, the template associated with the first category, the template including second instructions to define a target state to be enforced on the cloud account.

16. The method of claim 15, wherein the metadata indicates the cloud resource is deployed on at least one of a public cloud or a private cloud.

17. The method of claim 15, wherein the first category is a cost category, a performance category, a networking category, or a security category.

18. The method of claim 15, further including associating the first percentage of the metadata with the first category via a machine learning (ML) algorithm.

19. The method of claim 15, wherein the second instructions correspond to generating a subscription of the cloud resource, generating a role assignment of the cloud resource, or generating a member account of the cloud resource.

20. The method of claim 15, wherein the template is an output template, the metadata corresponding to a requested template, the requested template requested based on an input from a user of the cloud resource, the user associated with the cloud account.
